(19) United States
(12) Patent Application Publication
(10) Pub. No.: US 2007/0195259 A1
(43) Pub. Date: Aug. 23, 2007

(54) Antimicrobial spectacle

(75) Inventor: Anders Olsson, Satofta (SE)

Correspondence Address: CLIFF D. WESTON;MICROBAN PRODUCTS COMPANY, 1115 VANSTORY DRIVE, SUITE 125, HUNTERSVILLE, NC, 28078, US

(73) Assignee: Microban Products Company, Huntersville, NC (US)

(21) Appl. No.: 11/359,007

(22) Filed: Feb. 22, 2006

(51) Int. Cl. G02C 1/00

(52) U.S. Cl. 351/43

(57) ABSTRACT

Antimicrobial eyeglasses have one or both of an antimicrobial lens and/or antimicrobial frame member. A lens can have an antimicrobial agent incorporated into the lens material or into a coating material of a coating layer affixed to the lens. A spectacle frame member has disposed therein or affixed thereto one or more antimicrobial agents. The frame member can include the front frame member, temple members, nose pads, or temple tips. The antimicrobial agent is non-releasably incorporated or affixed, such that the frame member exhibits a persistent antimicrobial property.

### FIELD OF THE INVENTION

The invention relates generally to a spectacle or eyeglass frame, and more particularly to a spectacle or an eyeglass frame, or part thereof, having an antimicrobial property.

### BACKGROUND OF THE INVENTION

Glasses, spectacles, or eyeglasses are frames bearing lenses worn in front of the human eyes. Generally the lenses provide corrective light refraction, although “costume” eyeglasses are known to be worn for purely aesthetic reasons. Costume glasses can include both untinted lenses and sunglasses. Additionally, eyewear can be donned for protective purposes, such as safety glasses worn by persons near machinery, chemicals, and the like.

Modern glasses are made of plastic and/or metal and typically are supported by pads on the bridge of the nose and by temples placed over the ears. The pads and earpiece members are conventionally manufactured of a polymeric material, generally selected for a combination of durability and softness.

Eyeglass frames can be grouped into three basic types: full, half-rimless, and rimless. A “full” eyeglass frame has a frame that completely encircles the lens. In a half-rimless eyeglass frame, there is no frame on the bottom or top of the lens. Most half-rimless frame styles have the frame on the top of the lenses, although some half-frames have the frame on the bottom portion of the lenses. Rimless eyeglass frames have no frame at all around the lens. Rimless eyeglasses come in three pieces (two temples and the nose bridge piece).

Glasses were originally made from glass, but many are now made from plastic. Conventionally preferred lens materials include polycarbonate, CR-39® (poly diallyl glycol carbonate), and Trivex® (a polyurethane or polyurethane-polyurea based material). Safety glasses are usually made with shatter-resistant plastic lenses to protect the eye from flying debris as well as from the lenses of the safety glasses themselves.

Coatings can be applied to most plastic lenses. Scratch-resistant coatings give treated lenses scratch resistance similar to that of glass. Non-reflective coatings also can be applied to lenses. The coating material can be an acrylic film layer applied to the lens.

Eyeglass frames and components thereof are commonly manufactured of one or more plastics. In particular, plastics such as zylonite (cellulose acetate or “Zyl”) in either solid or laminated structures, permits a layered or mottled coloring. Propionate, a nylon-based plastic that is hypoallergenic, also is used for its light weight and different look and feel. Eyeglass frames constructed of nylon have been known since the late 1940s. Because of brittleness and other problems, eyeglass manufacturers generally use blended nylon, such as polyamides, co-polyamides and gliamides.

Nylon is also a preferred material for sports and performance frames—typically made of gliamides, which are very resistant to hot and cold and are more flexible, yet also stiff. Nylon is also easily molded into wraparound styles, as well as other shapes that are difficult to produce.

Metal eyeglass frames also are known in the art. By way of example and not limitation, such metals can include Monel® (actually a mixture of any of a broad range of metals); titanium; alloys that are combinations of titanium and other metals, such as nickel or copper; beryllium; stainless steel; TiCrAl and Flexon® (titanium alloys); and aluminum and aluminum alloys

Sunglasses and/or eyeglasses fitted with corrective lenses typically are worn by only one user, as the type and degree of correction will be specific to that user. Conversely, safety glasses (usually having clear, non-corrective lenses) may be worn by many different users in a laboratory or industrial setting.

In either instance, the frame members of eyeglasses are handled by the user in the course of putting on and removing the glasses. Further contact is made between the eyeglass frame members and the wearer's nose bridge and ears, upon which the eyeglass frame generally rests. Contact with the wearer's hands facilitates the deposit of microbes onto the eyeglass frame, permitting the eyeglass frame to act as a vector to deliver deposited microbes to a second wearer or to a susceptible part of the first wearer's person.

For example, microbes residing behind the wearer's ear can be transferred to the eyeglass frame; upon removal of the eyeglasses, the microbes then are transferred to the wearer's hand, and then from hand to eye, mouth, nose, or the like. Similarly, safety glasses in a commercial facility can be contaminated by a first wearer, and the microbes subsequently transferred to a second wearer. Microbial communication can be especially prevalent in health care and laboratory settings.

### DETAILED DESCRIPTION OF THE PREFERRED EMBODIMENT(S)

As used herein the term “antimicrobial agent” is used to encompass materials, typically chemicals, that kill microbes or retard the growth of microbes to a statistically significant degree. The term “antimicrobial agent” should be understood to include bactericides, fungicides, and other such agents. The terms “antimicrobial”, “bactericide” and “fungicide” are well-known to those skilled in the art and their meanings will be readily discerned by the context in which each term is used.

The elements of a spectacle frame (e.g., front member, side or temple member, nose bridge) are very well known in the art and need not be shown by illustration here.

In a first lens embodiment, a polycarbonate lens has applied thereon an acrylic coating layer, the acrylic layer having disposed therein a first antimicrobial agent. The antimicrobial acrylic coating does not perturb the optical properties of the lens, but imparts an antimicrobial character to the finished lens.

Prototype polycarbonate lenses were made having an acrylic coating layer thereon with 2,4,4′-trichloro-2′-hydroxydiphenyl ether incorporated therein at concentrations of 0.05%, 0.2%, 0.3%, 0.5% and 1.0% by weight of the finished lens plastic. The resultant lenses demonstrate an antimicrobial property in laboratory tests against Staphylococcus aureus and Escherichia coli 0157. Lenses at all sampled concentrations showed a reduction in microbe levels in the range of about 90% to about 99% after 24 hours in both S. aureus and E. coli 0157 cultures.

A lens can be coated with more than one coating layer. In such cases, the antimicrobial agent preferably is present at least in the outermost coating layer—that is, the most superficial coating layer. Such placement maximizes the probability that microbes contacting the lenses will contact the antimicrobial coating layer.

Some migration of the antimicrobial agent within the coating layer or adjacent structures can be expected. The degree of migration is dependent on the particular materials as well as the identity of the incorporated antimicrobial agent(s). In the above example, 2,4,4′-trichloro-2′-hydroxydiphenyl ether migrates slowly in acrylic materials. For this example, therefore, it is preferred that the antimicrobial agent be disposed in the topmost coating layer where multiple coatings are applied to the lens.

In a first frame embodiment, one or more antimicrobial agents are incorporated into a polymer from which the eyeglass frame element(s) is/are manufactured. An illustrative and non-limiting example would be an eyeglass frame comprising a lens-holding element (“frame front”, which may be a unitary piece or two eyepieces connected by a bridge) and two side piece elements (“frame temples”). An antimicrobial agent such as triclosan can be incorporated into the cellulose acetate polymer matrix of one or more frame elements.

Effective antimicrobial agents include triclosan (2,4,4′-trichloro-2′-hydroxydiphenyl ether); ortho phenyl phenol (OPP; CAS No. 90-43-7); isothiazolone-based compounds such as those selected from the group consisting of 1,2-benzisothiazolin-3-one (CAS No. 2634-33-5), N-butyl-1,2-benzisothiazolin-3-one (CAS No. 4299-07-4), 2-octyl-isothiazolone (CAS No. 26530-20-1), 4,5-dichloro-2-N-octyl-3(2H)-isothiazolone (CAS No. 64359-81-5), methyl-3(2H)-isothiazolone (CAS No. 2682-20-4), and chloro-2-methyl-3(2H)-isothiazolone (CAS No. 26172-55-4); diiodomethyl p-tolylsulfone; zinc and sodium pyrithiones; azoles (such as propiconazoles), polyhexamethylene biguanide hydrochloride (PMBH); 3,4,4′-trichlorocarbanilide; titanium dioxide; and barium metaborate.

Silver, copper or zinc can also be used in various forms, such as elemental, ion, zeolite, sol/gel, or amorphous glass powder. The general concept being such antimicrobial agents is that the inorganic antimicrobial be disposed in the frame polymer in an ion-exchangeable form. In some cases, it may be desirable to add a dispersing agent with the antimicrobial agent to prevent agglomeration of the antimicrobial agent.

In a second frame embodiment, a safety eyeglass frame can be constructed of nylon with an antimicrobial agent incorporated therein. Manufacturing methods for nylon fames elements typically involve higher temperatures or other parameters than most organic antimicrobial agents can withstand. Suitable antimicrobial agents for incorporation into nylon therefore include metallic antimicrobial agents.

In a third frame embodiment, the eyeglass frame piece can be constructed of a metal, such as stainless steel. A powder coated layer can be applied to the metal of the frame member, an antimicrobial agent disposed in the powder coat layer.

Ancillary frame elements can include nose pads, ear pads, and the like. Nose pads are mounted at the nose bridge and serve two primary functions: to increase frictional resistance to prevent the eyeglasses sliding down the wearer's nose, and to reduce discomfort associated with long-term pressure of the eyeglasses of the bridge of the wearer's nose. Pads typically are made of a low-durometer plastic or polymer, such as silicone, polyvinyl chloride, and other suitable polymers.

Polymeric elements also can be affixed to the frame temples to increase friction and help retain the eyeglasses on the wearer's head. Such elements, sometimes referred to as “temple tips”, generally are constructed of softer, higher-tack polymeric compositions than the material of the eyeglass frame itself.

Nose pads, temple tips, and the like also can have incorporated therein one or more antimicrobial agents. As these elements are in direct and constant contact with the wearer's skin, they benefit greatly from an added antimicrobial property. This benefit grows in glasses destined for use by multiple wearers, such as safety glasses in industrial or laboratory settings.

It will therefore be readily understood by those persons skilled in the art that the present composition and methods are susceptible of broad utility and application. Many embodiments and adaptations other than those herein described, as well as many variations, modifications and equivalent arrangements, will be apparent from or reasonably suggested to one of ordinary skill by the present disclosure and the foregoing description thereof, without departing from the substance or scope thereof.

Accordingly, while the present composition and methods have been described herein in detail in relation to its preferred embodiment, it is to be understood that this disclosure is only illustrative and exemplary and is made merely for purposes of providing a full and enabling disclosure. The foregoing disclosure is not intended or to be construed to limit or otherwise to exclude any such other embodiments, adaptations, variations, modifications and equivalent arrangements.

What is claimed is:

1. Antimicrobial eyeglasses, comprising:
an eyeglass lens member constructed of a lens material;
a first coating layer associated with the lens; and
a first antimicrobial agent disposed within one of the lens material or the first coating layer.

2. The antimicrobial eyeglasses of claim 1 wherein the first antimicrobial agent is disposed within the lens material.

3. The antimicrobial eyeglasses of claim 1 wherein the first antimicrobial agent is disposed within the first coating layer.

4. The antimicrobial eyeglasses of claim 3 wherein the first coating layer is an acrylic material.

5. The antimicrobial eyeglasses of claim 1 wherein the antimicrobial agent is selected from the group consisting of 2,4,4′-trichloro-2′-hydroxydiphenyl ether; o-phenyl phenol; an isothiazolone-based compound; diiodomethyl p-tolylsulfone; a zinc pyrithione, a sodium pyrithione; an azole; polyhexamethylene biguanide hydrochloride; and 3,4,4′-trichlorocarbanilide.

6. An antimicrobial eyeglass frame, comprising:
an eyeglass frame member constructed of a frame material; and
a first antimicrobial agent disposed within or affixed to a surface of the frame material.

7. The antimicrobial eyeglass frame of claim 6 wherein the frame material is a polymer resin.

8. The antimicrobial eyeglass frame of claim 7 wherein the antimicrobial agent is an organic antimicrobial agent.

9. The antimicrobial eyeglass frame of claim 8 wherein the organic antimicrobial agent is selected from the group consisting of 2,4,4′-trichloro-2′-hydroxydiphenyl ether; ortho phenyl phenol; an isothiazolone-based compound; diiodomethyl p-tolylsulfone; a zinc pyrithione, a sodium pyrithione; an azole; polyhexamethylene biguanide hydrochloride; and 3,4,4′-trichlorocarbanilide.

10. The antimicrobial eyeglass frame of claim 7 wherein the antimicrobial agent is a metallic antimicrobial agent.

11. The antimicrobial eyeglass frame of claim 10 wherein the metallic antimicrobial agent is selected from the group consisting of titanium dioxide, barium metaborate, a silver compound, a zinc compound, and a copper compound.

12. The antimicrobial eyeglass frame of claim 10 wherein the metallic antimicrobial agent is an elemental compound, an ionic compound, a zeolite compound, a sol/gel compound, or an amorphous glass powder compound.

13. The antimicrobial eyeglass frame of claim 6 wherein the frame material is a metal having a film layer thereon, the film layer including a first antimicrobial agent.

14. The antimicrobial eyeglass frame of claim 13 wherein the film layer is a powder coat layer.

15. The antimicrobial eyeglass frame of claim 13 wherein the film layer is a dip-coat layer.

16. The antimicrobial eyeglass frame of claim 13 wherein the antimicrobial agent is an organic antimicrobial agent.

17. The antimicrobial eyeglass frame of claim 16 wherein the organic antimicrobial agent is selected from the group consisting of 2,4,4′-trichloro-2′-hydroxydiphenyl ether; ortho phenyl phenol; an isothiazolone-based compound; diiodomethyl p-tolylsulfone; a zinc pyrithione, a sodium pyrithione; an azole; polyhexamethylene biguanide hydrochloride; and 3,4,4′-trichlorocarbanilide.

18. The antimicrobial eyeglass frame of claim 16 wherein the antimicrobial agent is a metallic antimicrobial agent.

19. The antimicrobial eyeglass frame of claim 18 wherein the metallic antimicrobial agent is selected from the group consisting of a silver compound, a zinc compound, and a copper compound.

20. The antimicrobial eyeglass frame of claim 18 wherein the metallic antimicrobial agent is selected from the group consisting of titanium dioxide, barium metaborate, a silver compound, a zinc compound, and a copper compound.

21. Antimicrobial eyeglasses, comprising:
an eyeglass frame member including any of a nose bridge member, a front frame member, a temple member, a side member, a nose pad, or a temple tip, wherein said frame member is constructed of a frame member material; and
a first antimicrobial agent durably and non-releasably associated with the frame material.

22. The antimicrobial eyeglasses of claim 21 wherein the first antimicrobial agent is at least one of incorporated within the frame member material or disposed in a film layer affixed to the frame member material.

23. The antimicrobial eyeglasses of claim 21, further comprising:
a second antimicrobial agent durably and non-releasably associated with the frame material;
wherein the second antimicrobial agent is different from the first antimicrobial agent.
